(19) United States
(12) Patent Application Publication
(10) Pub. No.: US 2005/0041447 A1
(43) Pub. Date: Feb. 24, 2005

(54) Power supply for battery-powered devices

(76) Inventor: Rajesh Khosla, Orange, OH (US)

Correspondence Address: John X. Garred;Tucker Ellis & West LLP, 1150 Huntington Building, 925 Euclid Avenue, Cleveland, OH, 44115, US

(21) Appl. No.: 10/643,711

(22) Filed: Aug. 18, 2003

(51) Int. Cl. H02M 7/00

(52) U.S. Cl. 363/125

(57) ABSTRACT

A power supply is disclosed which includes a transformer unit for converting AC voltage to DC voltage. An end effecter is provided and is electrically connected to the transformer unit for receiving DC voltage. The end effecter is received in a battery receptacle of a battery-powered item, to supply electrical power thereto.

### BACKGROUND OF THE INVENTION

The present invention is directed to the field of power supplies, particularly those of the type used in devices that accept disposable batteries. In a retail establishment, it is common to have displays that include battery-powered product items. It is widely appreciated in retail business that the effectiveness of the display is greatly enhanced by including a working demonstration model of the product item. However, in the case of a battery-powered product, the batteries are quickly depleted if the product runs continuously for a period of time. As a result, the batteries must be changed frequently, resulting in considerable time and effort on the part of retail personnel, and also expense in consumption of replacement batteries.

Another problem with battery-powered demonstration models is variable power output. Even though a battery may power on item for a period of time, the battery quickly loses voltage, causing the item to “slow down” in its performance. Such performance would be undesirable in that it the item would not adequately demonstrate the product. In order to solve this problem, the batteries would need to be changed even more frequently, resulting in additional time, effort and battery expense.

### SUMMARY OF THE INVENTION

The difficulties and drawbacks of previous approaches are overcome by the power supply of the present invention which includes a transformer/rectifier unit for converting AC voltage to a suitable DC voltage. An end effecter is provided and is electrically connected to the transformer/rectifier unit for receiving DC voltage. The end effecter is received in a battery receptacle of a battery-powered item, to supply electrical power thereto.

As will be realized, the invention is capable of other and different embodiments and its several details are capable of modifications in various respects, all without departing from the invention. Accordingly, the drawings and description are to be regarded as illustrative and not restrictive.

### BRIEF DESCRIPTION OF THE DRAWINGS

FIG. 1 shows a transformer unit connected to a plurality of end effecters, in accordance with the present invention.

FIGS. 2A, 2B and 2C show various end effecter arrangements received in a battery receptacle, in accordance with the present invention.

FIG. 3 shows a connection arrangement for connecting a plurality of end effecter arrangements.

### DETAILED DESCRIPTION OF THE INVENTION

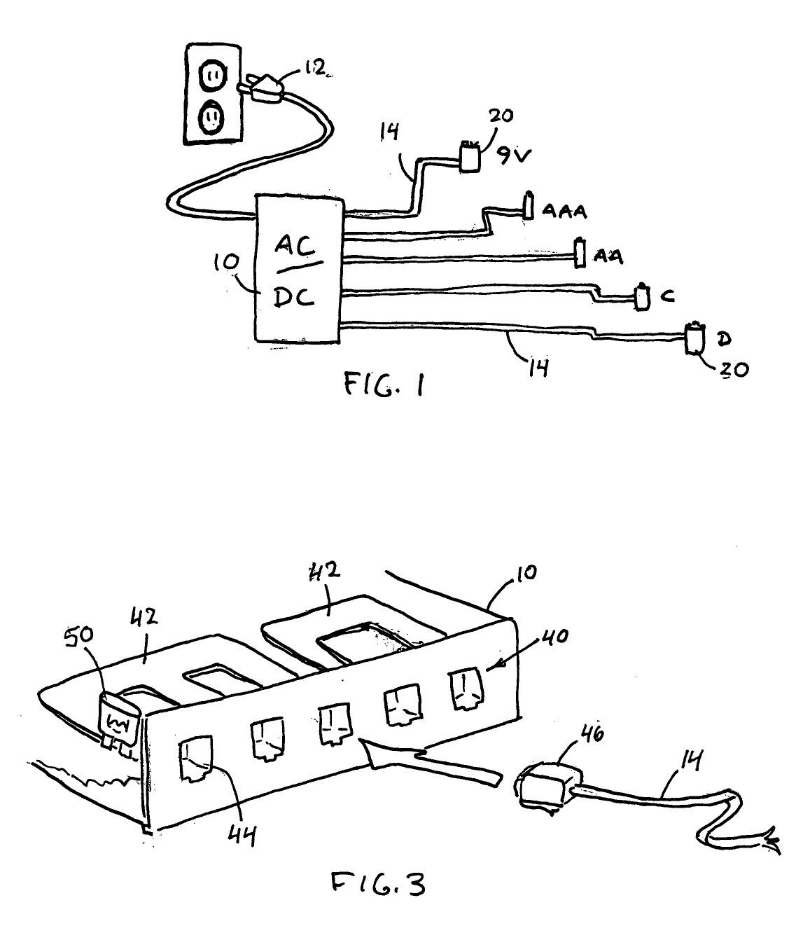

As shown in FIG. 1, a power supply transformer unit 10 is employed for converting AC voltage to a suitable DC voltage. In the preferred embodiment, the power supply 10 may include an electrical plug 12 for connecting to basic 110V AC electrical service. The power supply 10 includes a transformer and rectifier unit that converts the AC voltage into DC voltage suitable for a battery-powered device, e.g. 1.5 V, 3.0 V, 9V, etc. The power supply 10 includes an output for receiving an electrical connector cable 14, which is in turn connected to an end effecter 20.

The end effecter 20 is preferably an electrical plug in general configuration of a standard removable battery, e.g. “AA,” “AAA,” “C,” “D,” “9V” or other such battery size configuration. The end effecter 20 is received in a battery receptacle 32 that is part of a battery-powered product item 30 to be demonstrated. The end effecter 20 respectively includes positive and negative electrical terminals for engaging the electrical contacts within the receptacle 32. In this way, power is supplied from the transformer unit 10 directly to the product item 30, without the use of replaceable batteries.

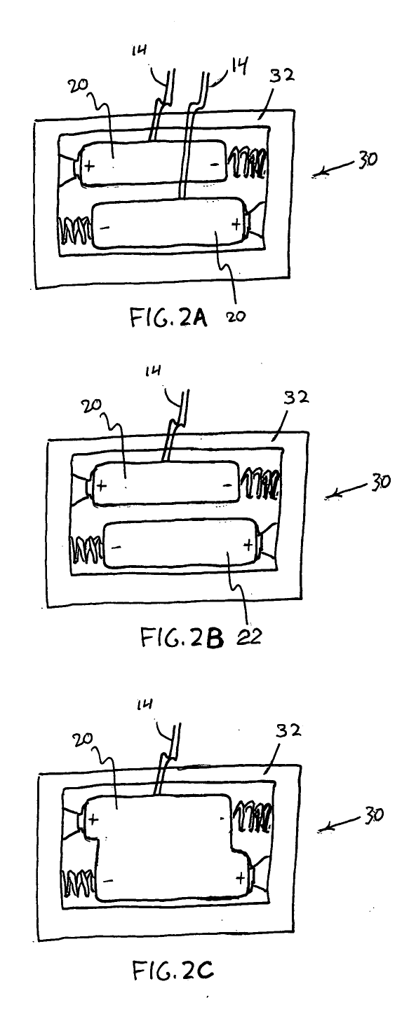

A typical battery-powered device includes two or more batteries, received in the receptacle 32. In one embodiment, as shown in FIG. 2A, a respective number of end effecters 20 can be inserted to substitute for the required number of batteries. Alternatively, as shown in FIG. 2B, a single end effecter 20 may be supplied for providing suitable voltage and one or more an additional “dummy batteries” 22 may be supplied so that a continuous connection can be made. Such a dummy battery 22 would be in the shape of an end effecter, but not connected to a cable 14, and would be a simple conductor to establish a circuit, without providing additional voltage. Alternatively, as shown in FIG. 2C, a single end effecter 20 could be provided and sized so as to fit into the space of multiple batteries. Other such variations could also be contemplated without departing from the invention.

As shown in FIG. 3, the present transformer unit 10 can include a plurality of outputs 40 for connecting a respective plurality of electrical cables 14. A large number of outputs 40 can be provided to provide electrical service to a large number of product items 30. If a number of product items having the same voltage are used, the outputs can all be connected to a common power bus 42 for supplying constant voltage. Also, a number of buses 42 can be provided supplying different voltages to respective pluralities of product items 30. The outputs can include a removable receptacle 44 used with standardized voltage output terminal, such as RJ11, RJ45, RCA mini-plugs, or some other such type of connection. In this scheme, the cables 14 would have a standardized mating connector 46 for connecting to the receptacle 44 for easy connection and disconnection. To minimize electrical shock risk, a control for short-circuited current can be employed. As shown, each set of voltage output terminal 40 could have an in-line fuse 50 to open the circuit in the case of a short circuit event.

To maximize the life of the product item being demonstrated, a variety of schemes can be employed. Some items maximize product life by not being turned on and off. For these type of devices, the transformer unit 10 box would supply the DC voltage and current continuously. For those items that require a rest period, the transformer unit 10 could provide the DC voltage and current on a cycle of “X” seconds on followed by “Y” seconds off where the values of X and Y can be determined to best extend the life of the product. To maximize the demonstration capability while minimizing the “On” period, a sensor could be employed that turns the devices on only when people are determined to be present within a radius of the item where demonstration would be useful. The sensor can be selected from sensors that detect light, sound, motion or any physical parameter than might be detected. Also, it should be appreciated that an extender cable could be employed so that the DC supply could reach battery operated devices in a remote location. It should also be understood that, in a location where a large number of battery-powered product items are present, any number of transformer units can be employed.

The present invention includes many benefits. With the present invention, the usage of batteries is greatly reduced, or even eliminated. Also, quite a bit of expense is saved since AC electrical service is much less expensive than the ongoing cost of disposable batteries. Further, the labor associated with repeatedly changing batteries is eliminated due to usage of the box and attendant cables. And also, the theft of batteries within the retail environment is reduced or eliminated in proportion to the reduction of batteries required for insertion into products being demonstrated. With the present invention, the product demonstration environment is maintained at a desirable level throughout the day rather than the constant interruptions and down periods associated with having multiple product items having their batteries run out at the same time. In these ways and many others, the present invention offers great advantages over previous-type implementations.

As described hereinabove, the present invention solves may problems associated with previous type systems. However, it will be appreciated that various changes in the details, materials and arrangements of parts which have been herein described and illustrated in order to explain the nature of the invention may be made by those skilled in the area within the principle and scope of the invention will be expressed in the appended claims.

1. A power supply comprising:
a transformer/rectifier unit for converting AC voltage to DC voltage;
an end effecter, electrically connected to the transformer unit for receiving DC voltage, for being received in a battery receptacle of a battery-powered item, to supply electrical power thereto.

2. The power supply of claim 1 wherein the end effecter is an electrical plug in general configuration of a standard removable battery, so as to be received in the battery receptacle.

3. The power supply of claim 2 wherein the end effecter includes positive and negative electrical terminals for engaging the electrical contacts within the receptacle.

4. The power supply of claim 2 wherein a respective number of end effecters are received in the receptacle to substitute for a respective number of batteries.

5. The power supply of claim 2 wherein at least one end effecter is received in the receptacle for providing suitable voltage and a remainder of dummy batteries are received in the receptacle to substitute for a respective number of batteries.

6. The power supply of claim 5 wherein at least one dummy battery is in the shape of an end effecter, and is a conductor to establish a circuit, without providing additional voltage.

7. The power supply of claim 1 wherein the end effecter is sized so as to fit into the space of multiple batteries.

8. The power supply of claim 1 wherein the transformer unit includes an electrical plug for connecting to basic 110V AC electrical service.

9. The power supply of claim 1 wherein the transformer unit includes at least one output for receiving at least one respective electrical connector cables, which are in turn connected to a respective number of end effecters.

10. The power supply of claim 9 wherein the at least one output comprises a plurality of outputs, and wherein at least a portion of the outputs are connected to at least one common power bus for supplying a predetermined voltage.

11. The power supply of claim 9 wherein the at least one output comprises a standardized voltage output receptacle, and wherein the at least one cable comprises a respective mating connector for connecting to the receptacle for easy connection and disconnection.

12. The power supply of claim 11 wherein the voltage output receptacle comprises an in-line fuse to open the circuit in the case of a short circuit event.
